(19) United States
(12) Patent Application Publication
(10) Pub. No.: US 2006/0029778 A1
(43) Pub. Date: Feb. 9, 2006

(54) Pleated composite fiber net, and article formed from the same

(75) Inventors: Teruaki Sekiguchi, Ichihara-shi (JP); Akira Yamanaka, Moriyama-shi (JP)

Correspondence Address: MERCHANT & GOULD PC, P.O. BOX 2903, MINNEAPOLIS, MN, 55402-0903, US

(73) Assignee: Chisso Corporation, Osaka-shi (JP)

(21) Appl. No.: 11/201,752

(22) Filed: Aug. 10, 2005

Related U.S. Application Data
(63) Continuation of application No. 10/399,644, filed on Apr. 16, 2003, now abandoned.

(51) Int. Cl. B32B 3/28; B32B 27/12; D04G 1/00; B32B 3/30; B32B 27/04; D04B 1/00

(52) U.S. Cl. 428/181; 442/1; 442/43

(57) ABSTRACT

A pleated composite fiber net formed of heat-adhesive composite fibers having a fineness of 200 to 2,500 dtex serving as warps and wefts in an opening size of strand of 0.5 to 5 mm, and heat-adhered at the intersections of said composite fibers; wherein the adhesive strength of the heat-adhered portions is 20 cN or higher.

This application is a Continuation of application Ser. No. 10/399,644, filed Apr. 16, 2003, which is the National Stage of Application PCT/JP00/07712, filed Nov. 1, 2000, and which application(s) are incorporated herein by reference.

### BACKGROUND OF THE INVENTION

1. Field of the Invention

The present invention relates to a composite fiber net manufactured by weaving heat-adhesive composite fibers having a fineness of 200 to 2,500 dtex into a net, and pleating the net; and to an article formed from such a composite fiber net.

2. Description of the Related Art

Heretofore, there has been known a pleated net fabricated by weaving multi-filaments consisting of single-component polyester fibers into raschel, applying an adhesive, pleating, and retaining the shape; and use of such a net for fabricating screen doors has been studied. However, screen doors fabricated from such a net have suffered problems such as the embrittlement, flaking, and the eventual dropout of adhesive components after repeated opening and closing operations. Furthermore, the net wherefrom adhesive components have been dropped off encounters difficulty in retaining its shape, and is easily deformed or broken by even a low wind pressure. Since such a pleated net, fabricated by fixing fibers to each other with adhesives, involves problems as described above, long-term use of the same has been known to be impossible.

Japanese Patent Application Laid-Open No. H1O-88470 discloses a pleated fabric consisting of a plain-woven cloth that uses polypropylene monofilaments as warps and wefts. The plain-woven cloth that constitutes the pleated fabric is composed of monofilaments consisting of the single component of polypropylene. In this plain-woven cloth, since the intersections of warps and wefts are not fixed, dislocation of joints or dropout of monofilaments occurs when the plain-woven cloth is pleated. When the filaments of the plain-woven cloth are fixed to each other by thermal adhesion, the temperature must be elevated to the melting point of polypropylene or above, and therefore, the monofilaments are easily deformed, raising the problem of a drop in the strength of yarns. Furthermore, when the strength of monofilaments is low, there has been a problem that the monofilaments are broken because of thinned fiber diameters at bent portions produced by pleating.

### SUMMARY OF THE INVENTION

The object of the present invention is to provide a pleated composite fiber net that is not broken by pleating, that does not cause the dislocation of net joints, and that exhibits excellent shape retention and wind-pressure resistance; and articles fabricated from such a pleated composite fiber net.

The present inventors have conducted repeated studies in an effort to solve the above-described problems in the conventional art, and have found that such problems can be solved by fixing the net composed of heat-adhesive composite fibers of a certain fineness by thermal adhesion, and pleating the net. On the basis of these findings, the present inventors completed the present invention.

The present invention has the following constitution:
[1] A pleated composite fiber net formed of heat-adhesive composite fibers having a fineness of 200 to 2,500 dtex serving as warps and wefts in an opening size of strand of 0.5 to 5 mm, and heat-adhered at the intersections of the composite fibers; wherein the adhesive strength of the heat-adhered portions is 20 cN or higher.
[2] The pleated composite fiber net according to [1], wherein the strength of the heat-adhesive composite fibers is 1.5 cN/dtex or higher, and the fiber diameter retention rate when a load of 40 N is applied in the direction perpendicular to the length of the fibers is 10% or higher.
[3] The pleated composite fiber net according to [1] or [2], wherein the bending resistance of the net in the direction parallel to the pleats of the pleated composite fiber net is 130 or more.
[4] The pleated composite fiber net according to any of [1] to [3], wherein the heat-adhesive composite fibers are composite fibers consisting of a low-melting-point resin and a high-melting-point resin which differ in melting point by 10 ° C. or more.
[5] The pleated composite fiber net according to any of [1] to [4], wherein the heat-adhesive composite fibers are filament yarns.
[6] The pleated composite fiber net according to any of [1] to [5], wherein the length between the peak and gullet of a pleat is 5 to 100 mm.
[7] A screen door fabricated from the pleated composite fiber net according to any of [1] to [6].
[8] An accordion screen door comprising the pleated composite fiber net according to any of [1] to [6], and a frame.
[9] A partition fabricated from the pleated composite fiber net according to any of [1] to [6].

### DETAILED DESCRIPTION OF THE PREFERRED EMBODIMENT

The present invention will be described in detail below.

In the pleated composite fiber net according to the present invention, the composite fibers composing the net are fixed to each other by the heat adhesion of the intersections of the composite fibers, and the net without looseness or dislocation can be obtained. In the pleated composite fiber net, heat adhesion of the intersections is essential for shape retention after repeated opening and closing, and for the ease of processing.

As the heat-adhesive composite fibers used in the present invention, composite fibers composed of at least two kinds of thermoplastic resins having different melting points are used. From the viewpoint of heat adhering, the low-melting-point resin and the high-melting-point resin that compose the composite fibers preferably differ in melting point by 10° C., more preferably 15° C. Also from the viewpoint of heat adhering, the low-melting-point resin that composes the composite fibers is preferably exposed on the surface of the fibers, and continues in the length direction. Specifically, filament yarns, such as heat-adhesive monofilaments and heat-adhesive composite multi-filaments, are used, and particularly, heat-adhesive composite monofilaments, which have excellent rigidity, are preferably used.

As the low-melting-point resin and the high-melting-point resin that compose the composite fibers, crystalline thermoplastic resins are used. Specific examples include polyethylenes, such as high-density polyethylene, low-density polyethylene, and linear low-density polyethylene; propylene-α-olefin copolymers, such as ethylene-propylene binary copolymers, and ethylene-propylene-butene-1 ternary copolymers; and thermoplastic resins, such as polypropylene, polyethylene terephthalate, and polyamides.

Example combinations of the low-melting-point resin and the high-melting-point resin (expressed in the order of the low-melting-point resin/the high-melting-point resin) include high-density polyethylene/polypropylene, linear low-density polyethylene/polypropylene, low-density polyethylene/polypropylene, binary copolymers or ternary copolymers of propylene and other α-olefin/polypropylene, linear low-density polyethylene/high- density polyethylene, low-density polyethylene/high-density polyethylene, various polyethylenes/polyethylene terephthalate, polypropylene/polyethylene terephthalate, binary copolymers or ternary copolymers of propylene and other α-olefin/polyethylene terephthalate, low-melting-point thermoplastic polyester/polyethylene terephthalate, various polyethylenes/nylon 6, polypropylene/nylon 6, binary copolymers or ternary copolymers of propylene and other α-olefin/nylon 6, nylon 6/nylon 66, and nylon 6/thermoplastic polyester.

Among these, the combinations of a polyolefin and another polyolefin, and a polyolefin and a polyester are preferable, and examples of such combinations include high-density polyethylene/polypropylene, ethylene-propylene-butene-1 ternary copolymer/polypropylene, ethylene-propylene binary copolymer/polypropylene, ethylene-propylene-butene-1 ternary copolymer/polyethylene terephthalate, and high-density polyethylene/polyethylene terephthalate.

Furthermore, the combination of a polyolefin and another polyolefin; for example, high-density polyethylene/polypropylene, ethylene-propylene-butene-1 ternary copolymer/polypropylene, and ethylene-propylene binary copolymer/polypropylene, is particularly preferable from the viewpoint of chemical resistance.

Example structures of the heat-adhesive composite fibers used in the present invention include the concentric sheath-core structure, the eccentric sheath-core structure, the parallel structure, the sea-island structure, and the hollow structure. From the viewpoint of heat adhesion, composite fibers of the concentric sheath-core structure, the eccentric sheath-core structure, and the parallel structure are preferably employed. Among these, the heat-adhesive composite fibers of the concentric sheath-core structure preferably have stable heat adhesion. When the composite fibers are composed of two components consisting of a low-melting-point resin and a high-melting-point resin, the ratio of the weight of the low-melting-point resin to the weight of the high-melting-point resin preferably falls within a range of 30:70 to 70:30, in view of heat adhesion. If the weight ratio of the low-melting-point resin is significantly lower than 30, the adhesion lowers markedly. On the other hand, if the weight ratio of the low-melting-point resin is significantly higher than 70, the rigidity of the fibers lowers markedly. Furthermore, when composite fibers are composed of three or more components, the weight ratio of the resin to be an adhesive component must be not lower than 30.

The heat-adhesive composite fibers used in the present invention are used as warps and wefts. As the heat-adhesive composite fibers used in the present invention, heat-adhesive composite monofilaments and heat-adhesive composite multi-filaments are preferably used, and examples of particularly preferable combinations of warps and wefts include heat-adhesive composite monofilaments/heat-adhesive composite monofilaments, heat-adhesive composite monofilaments/heat-adhesive composite multi-filaments, and heat-adhesive composite multi-filaments/heat-adhesive composite monofilaments. When heat-adhesive composite monofilaments are used, fineness means the single-yarn fineness of the single-yarn heat-adhesive composite monofilaments, and heat-adhesive composite monofilaments of fineness falling within the range of 200 to 2,500 dtex are preferably used. When heat-adhesive composite multi-filaments are used, fineness means the total fineness of a number of heat-adhesive composite multi-filaments, and heat-adhesive composite multi-filaments of fineness falling within the range between 200 and 2,500 dtex are preferably used. The combination of fineness of fibers used for warps and wefts can be optionally selected depending on the application. Here, if the fineness of heat-adhesive composite fibers is significantly lower than 200 dtex, not only is the rigidity of the obtained net lowered, but also the fibers may be broken upon pleating. Furthermore, the strength of pleats of the pleated composite fiber net obtained is markedly lowered. On the other hand, if the fineness of the heat-adhesive composite fibers is significantly higher than 2,500 dtex, pleating will become difficult. In view of processing, the fineness preferably falls within the range of 250 to 1,000 dtex, more preferably 300 to 750 dtex.

To the heat-adhesive composite fibers used in the present invention, additives may be added within the range not interfering with the effect of the present invention. Such additives include a coloring agent, a flame retardant, an antibacterial agent, and a stabilizer. Examples of coloring agents include titanium oxide and carbon black, and the addition of these additives enhances the hiding effect. Since the main application of the pleated composite fiber net of the present invention is screen doors, it is used in an environment where it is exposed to the sunlight for a long time. Therefore, addition of a stabilizer such as a weather resistant agent (light resistant agent) is preferable, for preventing the photo-degradation of the heat-adhesive composite fibers and improving the durability of the pleated composite fiber net. The quantity of the additives to be added should be determined in view of the kind of the thermoplastic resin that composes the composite fibers, the application of the present invention, and the place and environment where the present invention is used.

In the pleated composite fiber net of the present invention, the adhesion strength of the intersection of fibers that compose the net must be 20 cN or more. Adhesion strength significantly lower than 20 cN may cause dislocation or loose joints of the net. The adhesion strength preferably falls within a range of about 20 to 400 cN, more preferably 30 to 200 cN, in view of the ease of processing.

In the pleated composite fiber net of the present invention, the strength of the heat-adhesive composite fibers that compose the net is preferably 1.5 cN/dtex or more. If the strength is significantly lower than 1.5 cN/dtex, breakage of fibers on pleating, or significant decrease in the strength of pleated portions may result. On the contrary, if the strength of the fibers is excessively high, processibility tends to lower. The strength of the composite fibers preferably falls within a range of 1.5 to 35.0 cN/dtex, more preferably 2.0 to 20.0 cN/dtex.

Preferably, the heat-adhesive composite fibers that compose the pleated composite fiber net of the present invention have a fiber-diameter retention rate of 10% or higher when subjected to a load of 40 N. If the fiber-diameter retention rate is significantly lower than 10%, breakage of the fibers may occur easily, and productivity may be lowered. The reason why the load is specified as 40 N is that the composite fiber net is subjected to a load of about 40 N when the net is pleated. Fiber-diameter retention rate means the diameter of a heat-adhesive composite fiber in the pleated portion after pleating (B) expressed as a percentage of the diameter of a heat-adhesive composite fiber before pleating (A), and is calculated from the following equation (1).
Fiber-diameter retention rate (%)={(B)/(A)}×100 (1)

In order to obtain a preferably pleated composite fiber net, the preferable fiber-diameter retention rate is 12% or more. Normally, heat-adhesive composite fibers of a fiber-diameter retention rate of 10% or more and 50% or less can be available.

From a portion between the peak and the gullet of the pleated composite fiber net of the present invention, a rectangular sample (200 mm parallel to the ridge direction of the peak×25 mm in the direction perpendicular to the ridge) was cut, and the bending resistance of the sample was measured in accordance with a method compliant with the cantilever method specified in JIS (Japanese Industrial Standards) L1096. The bending resistance is preferably 130 (mm) or more. If the bending resistance is significantly lower than 130, the rigidity as a net is lowered. Therefore, the net is easily deformed by wind pressure. If a rectangular sample of the size required for the measurement is not available, the sample may be cut from the net before pleating, and the bending resistance of this sample may be measured. This measured value may be used as the bending resistance of the pleated composite fiber net.

Although the length between a peak and a gullet of the pleated composite fiber net of the present invention may be optionally selected depending on the applications or purposes of use, it normally falls within the range of 5 to 100 mm. If the length between a peak and a gullet is significantly less than 5 mm, as has been known, the repulsive force of the net after pleating increases, and processing becomes difficult, resulting in lower productivity. Although the upper limit of the length between a peak and a gullet depends on the application, when the net is used to fabricate screen doors, a practical limit of 100 mm is preferable, so that the thickness of the screen door when folded is not excessive.

The opening size of strand of the pleated composite fiber net of the present invention must fall within a range of 0.5 mm to 5 mm. The opening size of strand of the composite fiber net used herein is the same as the opening size of strand of the plain net before pleating (hereafter, the plain net before pleating is referred to as simply the plain net), and means the length between fibers adjacent to each other in a woven net. If the opening size of strand is significantly less than 0.5 mm, the fibers of the plain net are excessively dense, and pleating tends to be difficult. Further, the air permeability of the net is lowered. In contrast, if the opening size of strand is significantly more than 5 mm, the rigidity of the net tends to lower, and when a plain net is woven, the fibers may run off the loom, resulting in low productivity.

In the pleated composite fiber net of the present invention, a plain net without pleating is first fabricated, and is then continuously or multiply pleated. The plain net is obtained by weaving the heat-adhesive composite fibers. Simultaneously with or after weaving, the plain net is subjected to heat treatment at a temperature of the softening point of the low-melting-point resin in thermo-compression bonding, or at a temperature of the melting point of the low-melting-point resin in hot-air bonding, so as to thermally adhere the intersections of the heat-adhesive composite fibers and to manufacture a composite fiber net.

Example apparatuses used in the above-described heat treatment include a hot-air heater, an infrared heater, a far-infrared heater, a high-pressure steam heater, an ultrasonic heater, a hot roll heater, and a thermo-compression roll heater. These apparatuses may be used singly or in combination. Particularly, the combined use of a hot-air heater and a hot roll heater, or a hot-air heater and a thermo-compression roll heater, can enhance the adhesion strength of the intersections of the composite fibers that compose the plain net.

The plain net used in the present invention is not limited to a specific weave pattern in the weaving. In other words, the arrangement of heat-adhesive composite fibers used in warps and wefts, or the number of fibers for a unit length are optionally determined in accordance with the setup of the opening size of strand. Although the woven structures include plain cloth, twill weave, satin weave, leno weave, and raschel weave, when ease of the control of the opening size of strand is desired, plain cloth is preferably used.

Pleating can be performed by any of known methods. Particularly, a method of heating the net in the pleat line direction and performing flat stretching, and a method of heating and stretching the net by pressing with a hot-stretching blade are preferably used for pleating. However, the present invention is in no way limited to these pleating methods.

The pleated composite fiber net of the present invention can be utilized as a screen door and a partition for dividing a space by inserting into s frame that can favorably fix the net, and fixing the four corners. The net can also be used as a curtain by fixing a side of the net to a frame. Fixation using a frame is only an example, and does not limit the present invention. The pleated composite fiber net of the present invention can also be utilized not only as household materials, but also in agricultural insect-proof nets, building materials, civil engineering materials, and many other applications. The pleated composite fiber net can also be used in combination with many other materials, such as fabrics, films, metal nets, construction materials, civil engineering materials, and agricultural materials.

### EXAMPLES

The present invention will be described in further detail by reference to examples and comparative examples; however, the present invention is not limited to these examples. The testing method utilized for evaluating the pleated composite fiber net and the articles fabricated from the pleated composite fiber net will be described below.

(Measurement of Fiber Strength)

By use of a Shimadzu Autograph AGS-500D tensile tester, fiber strength was measured under the conditions of a stretching speed of 100 m/min and a clamp distance of 100 mm. The sample was a single fiber of about 15 cm length cut from the net in parallel to the pleat. Ten samples were measured, and the average was recorded as the measured value.

(Measurement of Adhesive Strength of Fiber Intersections)

By use of a Shimadzu Autograph AGS-500D tensile tester, the adhesive strength of fiber intersections was measured under the conditions of a stretching speed of 100 mm/min and a clamp distance of 100 mm. Rectangular samples each having a width formed of two fibers running parallel to the pleats and a length of 15 cm were cut from the net, and a slit of about 7 cm was cut along the centerline from one end of a rectangle forming two separate fibers. The two fibers were held with the upper and lower chucks of the tensile tester, respectively. Ten samples were measured, and the average was recorded as the measured value.

(Fiber-Diameter Retention Rate)

An iron rod of a diameter of 1.2 mm heated to 100° C. was placed on the sample, and the sample was pressurized for 10 seconds by use of a pressing machine. The pressing machine had upper and lower platens that could be heated, and both platens had been heated to 40° C. in advance. The pressure of the press was 40 N. After pressurizing, the diameter of the pressurized fiber was measured, and the fiber-diameter retention rate was calculated. The sample was a single fiber cut from the net in parallel to the pleat. Ten samples were measured, and the average was recorded as the measured value.

(Bending Resistance)

The bending resistance was measured in accordance with the cantilever method of JIS L1096. The sample (200 mm length in a direction parallel to the ridge direction of the peak×25 mm in the direction perpendicular to the ridge) was cut from the portion between the peak and the gullet of the net so as not to have pleats in the sample, and was used for measurement. When a sample of the size required for the measurement was not available, the sample was cut from the net before pleating by the width of 25 mm, and the bending resistance of this sample was measured. This measured value was used as the bending resistance of the pleated composite fiber net.

All the pleating methods described in examples and comparative examples were commonly employed methods. Specifically, there was used a method wherein an iron rod of a diameter of 1.2 mm heated to 100° C. is brought into contact with the net, and the fibers are partly compressed by a load of 40 N to thereby form pleats continuously in parallel to the wefts of the net. The optimal temperature of the iron rod depends on the type, temperature, and fineness of the resin that composes the fibers; however, since the above-described conditions are at least required in order to realize good pleating properties, the pleating conditions for the examples and comparative examples were unified. Hereinafter, the above-described method is abbreviated as the pleating process.

### Example 1

Heat-adhesive composite monofilaments of a sheath-core structure having a fineness of 320 dtex, wherein an ethylene-propylene-buten-1 ternary copolymer having a melting point of 133° C. served as the sheath component, polypropylene having a melting point of 162° C. served as the core component, and the weight ratio of the sheath and core components was 40:60, were woven so that the opening size of strand was 1 mm so as to obtain a plain-woven net. Then, the net was subjected to heat treatment by use of a hot-air heater of a measured temperature of 150° C., to thereby obtain a flat net wherein the intersections of the heat-adhesive composite monofilaments were thermally adhered. Furthermore, this flat net was pleated to form a pleated composite fiber net wherein the length between the peak and the gullet was 12 mm. The obtained composite fiber net could be opened, closed, or stretched in the manner of an accordion. The strength, adhesion strength, fiber-diameter retention rate, and bending resistance of the pleated composite fiber net were measured and evaluated. The results are shown in Table 1.

### Example 2

A screen door was fabricated from a composite fiber net of the same constitution as the composite fiber net of Example 1, and the screen door exhibited good performance.

### Example 3

Heat-adhesive composite monofilaments of a sheath-core structure having a fineness of 200 dtex, wherein high-density polyethylene having a melting point of 132° C. served as the sheath component, polypropylene having a melting point of 162° C. served as the core component, and the weight ratio of the sheath and core components was 40:60, were woven so that the opening size of strand was 1 mm, to thereby obtain plain-woven net. Then, the net was subjected to heat treatment by use of a hot-air heater of a measured temperature of 150° C., to thereby obtain a flat net wherein the intersections of the heat-adhesive composite monofilaments were thermally adhered. Furthermore, this flat net was pleated so as to form a pleated composite fiber net for screen doors wherein the length between the peak and the gullet was 50 mm. The obtained composite fiber net could be opened, closed, or stretched in the manner of an accordion. The strength, adhesion strength, fiber-diameter retention rate, and bending resistance of the pleated composite fiber net for screen doors were measured and evaluated. The results are shown in Table 1.

### Example 4

A screen door was fabricated from a composite fiber net of the same constitution as the composite fiber net of Example 3, and the screen door exhibited good performance.

### Example 5

Heat-adhesive composite monofilaments of a sheath-core structure having a fineness of 1,000 dtex, wherein an ethylene-propylene-buten-1 ternary copolymer having a melting point of 133° C. served as the sheath component, polypropylene having a melting point of 164° C. served as the core component, and the weight ratio of the sheath and core components was 50:50, were woven so that the opening size of strand was 3 mm, to thereby obtain a plain-woven net. Then, the net was subjected to heat treatment by use of a hot-air heater of a measured temperature of 150° C., to thereby obtain a flat net wherein the intersections of the heat-adhesive composite monofilaments were thermally adhered. Furthermore, this flat net was pleated so as to form a pleated composite fiber net for screen doors wherein the length between the peak and the gullet was 100 mm. The obtained composite fiber net could be opened, closed, or stretched in the manner of an accordion. The strength, adhesion strength, fiber-diameter retention rate, and bending resistance of the pleated composite fiber net for screen doors were measured and evaluated. The results are shown in Table 1.

### Example 6

A screen door was fabricated from a composite fiber net of the same constitution as the composite fiber net of Example 5, and the screen door exhibited good performance.

### Comparative Example 1

The plain-woven net obtained in Example 1 was pleated so as to form a pleated composite fiber net, wherein the length between the peak and the gullet was 12 mm.

### Comparative Example 2

A screen door was fabricated from a composite fiber net of the same constitution as the composite fiber net of Comparative Example 1.

### Comparative Example 3

Single-component monofilaments of a fineness of 300 dtex consisting of polypropylene of a melting point of 164° C. were pleated so as to form a pleated net, wherein the length between the peak and the gullet was 12 mm.

### Comparative Example 4

A screen door was fabricated from a composite fiber net of the same constitution as the composite fiber net of Comparative Example 3. In both Comparative Examples 1 and 3, since the intersections were not adhered, dislocation of joints occurred in obtained pleated nets, and nets having uniform opening size of strand could not be obtained. Fibers were loosened from the ends of the net, and the net was unusable. Furthermore, this pleated net was not suitable for fabrication of screen doors.

### Comparative Example 5

Heat-adhesive composite monofilaments of a sheath-core structure having a fineness of 100 dtex, wherein an ethylene-propylene-buten-1 ternary copolymer having a melting point of 133° C. served as the sheath component, polypropylene having a melting point of 164° C. served as the core component, and the weight ratio of the sheath and core components was 50:50, were woven so that the opening size of strand was 1 mm, to thereby obtain a plain-woven net. Then, the net was subjected to heat treatment by use of a hot-air heater of a measured temperature of 150° C., to thereby obtain a flat net wherein the intersections of the heat-adhesive composite monofilaments were thermally adhered. Furthermore, this flat net was pleated so as to form a pleated composite fiber net for screen doors, wherein the length between the peak and the gullet was 15 mm. The strength, adhesion strength, fiber-diameter retention rate, and bending resistance of the pleated composite fiber net for screen doors were measured and evaluated. The results are shown in Table 1. As Table 1 shows, the pleated net obtained in Comparative Example 5 had low strength because of low fineness and an external pressure easily cut the fibers because of small fiber-diameter retention rate. Furthermore, the fibers were cut during the course of pleating. This showed that the pleated net was not suitable for fabricating screen doors.

### Example 7

The pleated composite fiber net obtained in Example 1 was inserted into an aluminum frame of a size of 2m×2m so as to fabricate a screen door having a frame. The aluminum frame of the screen door has a tray (concave structure) so that the net does not run off, and the net travels freely along the tray so as to open and close the door. The pleated composite fiber net was extended so that the angle of a pleat became 90°, and the net was subjected to wind pressure of the wind of 7 m/sec from 2 m in front of the net (equivalent to the a Beaufort number of 5). The pleated composite fiber net that composed the screen door did not bend or deform, did not run off the tray, and exhibited good shape-retention properties. Opening and closing after the test were smooth and favorable. Therefore, the pleated composite fiber net and the screen door were found to have high resistance to external pressure.

### Comparative Example 6

In Example 7, a raschel-woven net consisting of polyester multi-filaments was pleated, whose shape was retained with a binder, and was subjected to the same test. As a result, the net was deformed by wind pressure, and the portion that received a strong wind ran off the frame. Furthermore, opening and closing after the test were significantly troublesome, because these had to be performed while correcting the deformed portions.

### INDUSTRIAL APPLICABILITY OF THE INVENTION

Since the pleated composite fiber net and the screen door of the present invention have excellent rigidity and shape-retention properties, they can be used widely not only in general household applications, but also in agricultural uses and construction uses such as public facilities. The pleated composite fiber net of the present invention can also be used in combination with other materials, such as fabrics, films, metal nets, construction materials, civil engineering materials, and agricultural materials.

TABLE 1

| Item | Unit | Example 1 | Example 3 | Example 5 | Comp. Ex. 1 | Comp. Ex. 3 | Comp. Ex. 5 |
|---|---|---|---|---|---|---|---|
| Fineness | dtex | 320 | 200 | 1,000 | 320 | 300 | 100 |
| Opening size of strand | mm | 1 | 1 | 3 | 1 | 1.2 | 1 |
| Adhesion strength | cN | 28.3 | 23.2 | 51.0 | 0 | 0 | 17.8 |
| Fiber strength | cN/dtex | 2.2 | 2.0 | 3.3 | 2.2 | 4.1 | 1.3 |
| Fiber diameter retention rate | % | 22.9 | 19.8 | 47.4 | 22.9 | 58.3 | 7.1 |
| Bending resistance | mm | 135.3 | 131.1 | 160.6 | 132.6 | 179.6 | 110.3 |
| Length between peak and gullet | mm | 12 | 50 | 100 | 12 | 12 | 15 |
| Melting-point difference between fibers | ° C. | 29 | 30 | 31 | 29 | — | 31 |
| Presence of dislocated or loose joints | — | No | No | No | Yes | Yes | Yes |

What is claimed is:

1. A pleated composite fiber net formed of heat-adhesive composite fibers having a fineness of 200 to 2,500 dtex serving as warps and wefts in an opening size of strand of 0.5 to 5 mm, and heat-adhered at the intersections of said composite fibers; wherein the adhesive strength of the heat-adhered portions is 20 cN or higher.

2. The pleated composite fiber net according to claim 1, wherein the strength of said heat-adhesive composite fibers is 1.5 cN/dtex or higher, and the fiber diameter retention rate when a load of 40 N is applied in the direction perpendicular to the length of the fibers is 10% or higher.

3. The pleated composite fiber net according to, wherein the bending resistance of the net in the direction parallel to the pleats of the pleated composite fiber net is 130 or more.

4. The pleated composite fiber net according to, wherein the heat-adhesive composite fibers are composite fibers consisting of a low-melting-point resin and a high-melting-point resin which differ in melting point by 10° C. or more.

5. The pleated composite fiber net according, wherein the heat-adhesive composite fibers are filament yarns.

6. The pleated composite fiber net according to, wherein the length between the peak and gullet of a pleat is 5 to 100 mm.

7. A screen door fabricated from the pleated composite fiber net according to.

8. An accordion screen door comprising the pleated composite fiber net according to, and a frame.

9. A partition fabricated from the pleated composite fiber net according to.
